(19) United States
(12) Patent Application Publication
(10) Pub. No.: US 2026/0302843 A1
(43) Pub. Date: Oct. 1, 2026

(54) MOTOR CORE FOR ELECTRIC VEHICLE COMPOSED OF DISSIMILAR MATERIALS AND METHOD FOR MANUFACTURING THE SAME

(71) Applicants: HYUNDAI MOTOR COMPANY, SEOUL (KR); KIA CORPORATION, SEOUL (KR)

(72) Inventors: Dohoon Kim, Hwaseong-si (KR); Jun Young Song, Hwaseong-si (KR)

(73) Assignees: HYUNDAI MOTOR COMPANY, SEOUL (KR); KIA CORPORATION, SEOUL (KR)

(21) Appl. No.: 19/265,862

(22) Filed: Jul. 10, 2025

(30) Foreign Application Priority Data
Mar. 26, 2025 (KR) 10-2025-0038685

(51) Int. Cl. H02K 1/14; H02K 15/026; H02K 15/0273

(52) U.S. Cl. CPC H02K 1/148; H02K 15/026; H02K 15/0273; H02K 2201/09; H02K 2215/00

(57) ABSTRACT

A motor core for an electric vehicle is provided, which may include a back yoke part formed of a first material that is a ferromagnetic material and having a cylindrical shape, a plurality of tooth coupling grooves formed as straight longitudinal grooves on an inner circumference of the back yoke part and formed at regular intervals, and a plurality of stator teeth respectively coupled to the tooth coupling grooves and forming stator slots where stator windings are coupled, wherein the stator teeth are made of a second material that is a soft magnetic amorphous material.

### CROSS REFERENCE TO RELATED APPLICATIONS

This present application claims the benefit of priority to Korean Patent Application No. 10-2025-0038685, filed on Mar. 26, 2025, in the Korean Intellectual Property Office, the entire disclosure of which is incorporated herein by reference.

### FIELD

The present disclosure relates to a motor core for an electric vehicle composed of dissimilar materials and a method for manufacturing the same, and more particularly to a motor core for an electric vehicle and a method for manufacturing the same that achieves higher efficiency by reducing energy loss by constructing the motor core with a tooth core part made of a soft magnetic amorphous material and a back yoke part made of an electrical steel material.

### BACKGROUND

A drive motor of an electric vehicle generally includes a stator and a rotor. The drive motor is a key component that converts electrical energy into mechanical energy to move the vehicle. Electric vehicles driven by motors are gaining attention for their higher energy efficiency and reduced exhaust emissions compared to internal combustion engine vehicles. The drive motor generates rotational force using electromagnetic interaction between the rotor and stator.

It is important to minimize unnecessary energy loss to ensure high efficiency of the drive motor. The driving efficiency of the motor has a significant impact on the driving performance of the electric vehicle.

Accordingly, research is being conducted to improve the driving efficiency of motors, and as one example, research to improve the driving efficiency of motors by reducing iron loss of the motor core is actively being carried out.

Electric vehicles are exposed to repeated impacts and thermal stress, so each component must also be designed for durability and ease of maintenance.

The core materials for rotors and stators in drive motors are generally soft magnetic materials, which are a type of ferromagnetic material.

The core material should have high magnetic flux density, low coercivity, high permeability, and low iron loss.

In particular, high magnetic flux density delays the magnetic saturation of the motor core, enabling the motor to be reduced in size. Low coercivity and high permeability contribute to improving motor efficiency by reducing hysteresis loss.

As lower iron loss in the motor core improves the electric vehicle's energy efficiency and driving performance, technologies that reduce iron loss in drive motor materials represent a critically important technical field.

Research and development has typically focused on continuously reducing the thickness of electrical steel plates to increase the efficiency of the drive motor. However, electrical steel plates that became too thin dramatically increased the difficulty of processing such as rolling, and the technology has reached a point where further motor efficiency improvements cannot be expected through manufacturing advancements alone.

In addition, as electric vehicle motors are increasingly operating at higher speeds, there was a limitation in improving the performance of the motor through reduced iron loss using only the existing electrical steel plate motor core method.

The matters described in this Background section are only for enhancement of understanding of the background of the disclosure, and should not be taken as acknowledgement that they correspond to prior art already known to those skilled in the art.

### SUMMARY

The following summary presents a simplified summary of certain features. The summary is not an extensive overview and is not intended to identify key or critical elements.

The present disclosure is directed providing a motor core for an electric vehicle and a method for manufacturing the same in which motor efficiency may be improved beyond levels achieved by thinning electrical steel sheets, which may be subject to physical limitations in how thin they can be made.

The present disclosure is further directed to providing a motor core for an electric vehicle and a method for manufacturing the same in which a soft magnetic metal ribbon having improved magnetic properties and low iron loss may be utilized without significantly increasing the cost of manufacturing a driving motor.

The present disclosure is further directed to providing a motor core for an electric vehicle and a method for manufacturing the same in which magnetic properties may be maintained without deterioration even when surface conditions, such as roughness or grooves, are present, which in some cases have been associated with phenomena such as cracks, burrs, voids, peeling, or corrosion.

Aspects of the present disclosure are not limited to those mentioned above, and other aspects that are not mentioned above may be clearly understood by those skilled in the art from the following description.

A motor core for an electric vehicle according to one embodiment of the present disclosure may include a back yoke part formed of a first material that is a ferromagnetic material and having a cylindrical shape, a plurality of tooth coupling grooves formed as straight longitudinal grooves on an inner circumference of the back yoke part and formed at regular intervals, and a plurality of stator teeth respectively coupled to the tooth coupling grooves and forming stator slots where stator windings are coupled, wherein the stator teeth are made of a second material that is a soft magnetic amorphous material.

In the motor core for an electric vehicle according to one embodiment of the present disclosure, the back yoke part may be formed by laminating and coupling a plurality of thin film sheets made of the first material.

In the motor core for an electric vehicle according to one embodiment of the present disclosure, the stator teeth may be formed by laminating and coupling a plurality of thin film sheets made of the second material.

In the motor core for an electric vehicle according to one embodiment of the present disclosure, each of the plurality of stator teeth may include a tooth base coupled along a longitudinal direction of a corresponding tooth coupling groove, a pair of tooth cores, with one tooth core provided on each side of the tooth base and projecting along a longitudinal direction of the tooth base, and tooth shoes projecting from opposite sides of an end of each tooth core.

In the motor core for an electric vehicle according to one embodiment of the present disclosure, each of the plurality of stator teeth may include a tooth base coupled along a longitudinal direction of a corresponding tooth coupling groove, a plurality of tooth cores provided on one surface of the tooth base and projecting, in parallel at regular intervals, in one direction from the one surface of the tooth base, and tooth shoes projecting from opposite sides of an end of each tooth core.

A method for manufacturing a motor core for an electric vehicle according to one embodiment of the present disclosure may include manufacturing a back yoke part by laminating a plurality of thin film sheets made of a first material that is a ferromagnetic material, manufacturing stator teeth by laminating a plurality of thin film sheets made of a second material that is a soft magnetic amorphous material, and press-fitting and coupling a plurality of the stator teeth to an inner circumference of the back yoke part.

In the method for manufacturing a motor core for an electric vehicle according to one embodiment of the present disclosure, the manufacturing the stator teeth may include preparing a soft magnetic ribbon roll wound with thin film sheets of a constant width made of the second material that is a soft magnetic amorphous material, unwinding the second material in the form of thin film sheets from the soft magnetic ribbon roll, and cutting the unwound thin film sheets into cutting ribbons having a predetermined width, laminating and pressing a predetermined number of the cutting ribbons to primarily bind the cutting ribbons, vacuum impregnating the primarily bound cutting ribbons, and processing a lamination block that has undergone the vacuum impregnation into a predetermined shape.

The method for manufacturing a motor core of an electric vehicle according to various aspects disclosed herein may further include applying an adhesive to at least one side of the lamination block that has been vacuum impregnated through the vacuum impregnation, to secondarily bind the lamination block.

In the method for manufacturing a motor core for an electric vehicle according to one embodiment of the present disclosure, in the laminating and pressing, a pair of plate-shaped steel plates each having an area larger than the cutting ribbons may be coupled with respective sides of the laminated plurality of cutting ribbons.

In the method for manufacturing a motor core for an electric vehicle according to one embodiment of the present disclosure, in the laminating and pressing, a gap between the pair of steel plates may be narrowed by a plurality of coupling units connecting the pair of steel plates, thereby pressing the plurality of cutting ribbons placed between the pair of steel plates.

In the method for manufacturing a motor core for an electric vehicle according to one embodiment of the present disclosure, in the press-fitting and coupling, the back yoke part may be fixed on a lower die, and an upper die may press the stator teeth from top to bottom to couple the stator teeth to respective tooth coupling grooves formed in the fixed back yoke part.

In the method for manufacturing a motor core for an electric vehicle according to one embodiment of the present disclosure, in the press-fitting and coupling, the stator teeth may be placed on top of a lower die in a state of being temporarily fixed on the lower die by a fixing module, and a plurality of pressing units provided on one side of an upper die may press the back yoke part toward the stator teeth placed on top of the lower die to couple each stator tooth to a corresponding tooth coupling groove among a plurality of tooth coupling grooves provided in the back yoke part.

According to embodiments of the present disclosure, operating efficiency of a drive motor may be improved by manufacturing the back yoke part and the tooth core part of the drive motor with dissimilar materials.

According to embodiments of the present disclosure, efficiency of a drive motor may be greatly improved without a significant increase in production cost, as the soft magnetic metal ribbon material is used only in the area of the motor core where magnetic flux and iron loss are concentrated.

According to embodiments of the present disclosure, the influence of various factors that previously deteriorated the magnetic properties of the motor core may be reduced.

According to embodiments of the present disclosure, continuous production and mass production of motor cores including amorphous or nanocrystalline metal ribbons with improved magnetic properties such as high magnetic flux density, high permeability, and low iron loss may be facilitated.

According to embodiments of the present disclosure, a high-efficiency drive motor with reduced energy loss compared to existing drive motors may be manufactured.

The effects of the present disclosure are not limited to those mentioned above, and other effects not mentioned may be clearly understood by those skilled in the art from the following description.

### BRIEF DESCRIPTION OF THE FIGURES

The foregoing and other aspects, as well as the following detailed description of the embodiments, should be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 is a perspective view schematically illustrating a stator core in a motor core for an electric vehicle according to one embodiment of the present disclosure.

FIG. 2 is a plan view illustrating the stator core in the motor core for an electric vehicle according to one embodiment of the present disclosure.

FIG. 3 is a partial sectional views illustrating the motor core for an electric vehicle according to one embodiment of the present disclosure.

FIG. 4 is a partial sectional views illustrating the motor core for an electric vehicle according to one embodiment of the present disclosure.

FIG. 5 is a partial sectional view illustrating external grooved portions in the motor core for an electric vehicle according to one embodiment of the present disclosure.

FIG. 6 is a perspective view schematically illustrating a stator core in a motor core for an electric vehicle according to another embodiment of the present disclosure.

FIG. 7 is a plan view illustrating the stator core in the motor core for an electric vehicle according to another embodiment of the present disclosure.

FIGS. 8 and 9 are partial sectional views illustrating the motor core for an electric vehicle according to another embodiment of the present disclosure.

FIG. 10 is a flow chart illustrating a method for manufacturing a motor core according to one embodiment of the present disclosure.

FIG. 11 is a flow chart illustrating a method for manufacturing a motor core according to one embodiment of the present disclosure.

FIG. 12 is a schematic diagram illustrating a process of manufacturing stator teeth in the method for manufacturing a motor core according to one embodiment of the present disclosure.

FIG. 13 is a schematic diagram illustrating a process of coupling each stator tooth to the back yoke part through the method for manufacturing a motor core according to one embodiment of the present disclosure.

FIG. 14 is a schematic diagram illustrating a process of coupling each stator tooth to the back yoke part through the method for manufacturing a motor core according to one embodiment of the present disclosure.

FIG. 15 is a schematic diagram illustrating a process of coupling each stator tooth to the back yoke part through the method for manufacturing a motor core according to one embodiment of the present disclosure.

FIG. 16 is a schematic diagram illustrating a process of each stator tooth being temporarily fixed by a fixing module and coupled to the back yoke in the method for manufacturing a motor core according to another embodiment of the present disclosure.

FIG. 17 is a schematic diagram illustrating a process of each stator tooth being temporarily fixed by a fixing module and coupled to the back yoke in the method for manufacturing a motor core according to another embodiment of the present disclosure.

### DETAILED DESCRIPTION

Hereinafter, embodiments disclosed in the present disclosure will be described in detail with reference to the accompanying drawings.

The same or similar reference numerals are used for the same or similar components, and repetitive descriptions may be omitted.

When a component is referred to as being "connected" or "coupled" to another component, it means that the component may be directly connected or coupled to the other component, or other components may intervene in between.

By contrast, when it is specified that a component is "directly connected" or "directly coupled" to another component, it means that no other component intervenes in between.

Expressions such as “comprise” or "include" or "have" used in this specification indicate that a certain feature, step, operation, component, part, or a combination thereof is included, and do not exclude the possibility of including one or more other features.

In addition, a first direction (X-axis direction), second direction (Y-axis direction), and third direction (Z-axis direction) mentioned in the present disclosure are used to describe three-dimensional shapes in three-dimensional space, and refer to directions that are orthogonal to each other.

The present disclosure may use ordinal numbers such as "first," "second," "third," etc., to refer to elements, and it should be noted that, unless explicitly indicated otherwise, these are merely used to distinguish between different elements and do not imply that the mentioned elements are necessarily provided in the indicated order in terms of time, space, or other aspects.

The present disclosure discloses a motor core (10) for an electric vehicle and a method for manufacturing the same.

The motor core (10) for an electric vehicle according to the present disclosure refers to a rotor core and/or a stator core (100) provided in the motor.

The motor core (10) for an electric vehicle and a method for manufacturing the same according to embodiments of the present disclosure are explained using the stator part of the motor as an example.

First, the motor core (10) for an electric vehicle according to one embodiment of the present disclosure will be described.

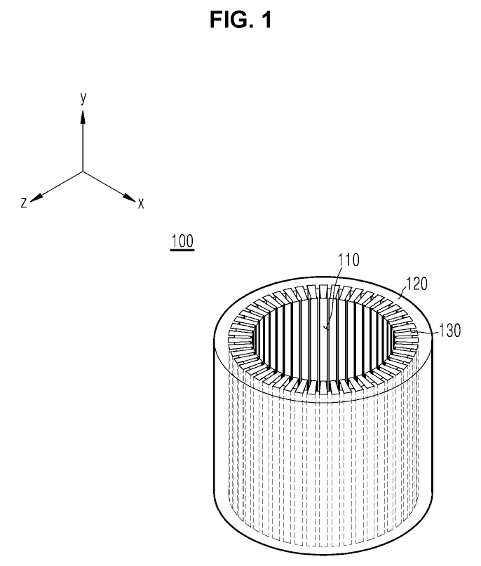

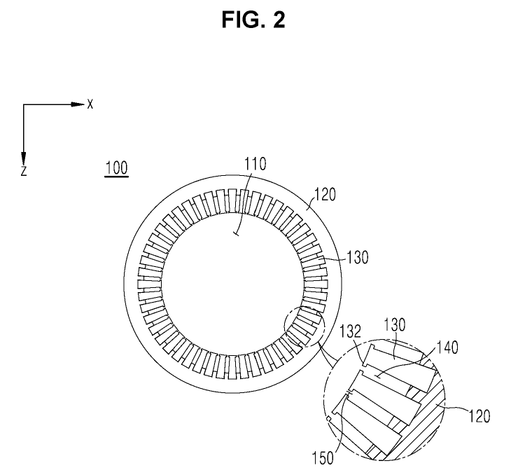

FIG. 1 is a perspective view schematically illustrating a stator core (100) in a motor core (10) for an electric vehicle according to one embodiment of the present disclosure, and FIG. 2 is a plan view illustrating the stator core (100) in the motor core (10) for an electric vehicle according to one embodiment of the present disclosure.

As shown in FIGS. 1 and 2, the stator core (100) may comprise a back yoke part (120) and a plurality of stator teeth (130).

The shape of the back yoke part (120) may be cylindrical. The back yoke part (120) may include a hollow part (110) with a circular cross-section at its center.

A plurality of tooth coupling grooves (122) may be formed on an inner circumference of the back yoke part (120). The plurality of tooth coupling grooves (122) may be arranged at regular intervals along a longitudinal direction of the hollow part (110).

Each of the tooth coupling grooves (122) may be a longitudinal groove formed on the inner circumference of the back yoke part (120), and may be formed in a straight line along a longitudinal direction of a passage formed by the hollow part (110).

Each of the tooth coupling grooves (122) may be provided on the inner circumference of the back yoke part (120), and the width of the grooves may become narrower toward the inside of the back yoke part (120).

A corresponding stator tooth (130) may be coupled to each of the tooth coupling grooves (122).

Each of the stator teeth (130) may include a tooth base (134) that is slidably coupled to the tooth coupling groove (122), a tooth core that is formed for a predetermined length in one direction and whose width gradually decreases as it gets farther from the tooth base (134), and tooth shoes (132) that protrude from opposite sides of the end of the tooth core.

The plurality of stator teeth (130) may be arranged at predetermined intervals along the inner circumference of the back yoke part (120). Spaces between the stator teeth (130) may form stator slots (140), which are spaces where stator windings (300) are coupled.

The stator windings (300) may also be coupled to each of the stator slots (140) through shoe slots (150). The shoe slots (150) may be formed as gaps between the tooth shoes (132) of adjacent stator teeth (130).

As shown, the plurality of stator teeth (130) may be coupled in parallel along the inner circumference of the back yoke part (120).

The stator slots (140) may be formed in each of the spaces between the stator teeth (130).

The inner ends of the stator teeth (130) may be formed as planes facing the inward direction, and a rotor (200) may be installed in an inner space surrounded by the inner ends of the stator teeth (130).

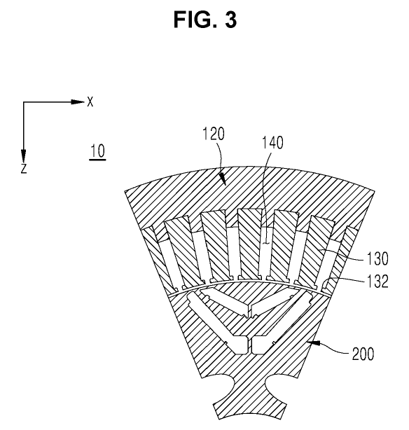

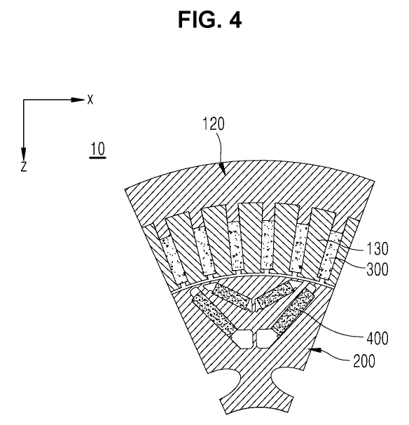

FIGS. 3 and 4 are partial sectional views illustrating the motor core (10) for an electric vehicle according to one embodiment of the present disclosure.

As shown in FIGS. 3 and 4, the cylindrical back yoke part (120) and the plurality of stator teeth (130) coupled thereto may form the basis of the stator core (100). The stator windings (300), which generate a magnetic field around them when current is applied, may be installed in each of the plurality of stator slots (140).

A rotor (200) may be placed in the hollow portion (110) of the stator core (100).

Depending on the embodiment to which the present disclosure is applied, the rotor (200) may include rotor windings (400). The rotor windings (400) allow magnetic flux to be formed in the rotor (200) under the influence of the generated magnetic field.

In one embodiment of the present disclosure, the back yoke part (120) may be made of a first material that is a ferromagnetic material. Each of the stator teeth (130) may be provided with a second material that is a soft magnetic amorphous material.

The back yoke part (120) may be made of the first material. The first material may be implemented as an electrical steel.

Specifically, a non-oriented silicon steel sheet containing a small amount of Si, Al, and trace amounts of Mn, Sn, Cr, etc. in iron may be used as the first material.

The first material may be prepared as thin film sheets with a thickness of approximately 0.1 mm to 0.5 mm, and the back yoke part (120) may be manufactured to a predetermined thickness by laminating these thin film sheets of the first material in multiple layers.

The second material may use a soft magnetic amorphous material or a soft magnetic nanocrystalline material.

The second material may first be manufactured as thin film sheets with a thickness of approximately 0.02 mm to 0.04 mm, and stator teeth (130) of a predetermined thickness may be manufactured by laminating these thin film sheets of the second material in multiple layers.

In one embodiment of the present disclosure, the stator teeth (130) may be manufactured by laminating thin film sheets of the second material, and the second material may be a melt of Fe-Si-B ternary master alloy. Some additive elements (Cu, Nb, Mo, Zr, P, C, and the like) may be added to the second material.

In the motor core (10) according to one embodiment of the present disclosure, in the stator core (100), based on FIG. 1, if the cross-sectional area is measured at any height along the Y-axis direction, the cross-sectional area of the back yoke part (120) appearing in each cross-section may be provided to be larger than the sum of the cross-sectional areas of the stator teeth (130).

More specifically, this numerical limitation is to control the application ratio of the relatively expensive second material and the relatively inexpensive and easy-to-manufacture first material, thereby reducing the increase in production cost of the motor core (10) while increasing the performance improvement that may be obtained by applying the second material.

In one embodiment of the present disclosure, the cross-sectional area of the back yoke part (120) and the sum of the cross-sectional areas of the stator teeth (130) may be configured in a ratio of 57:43.

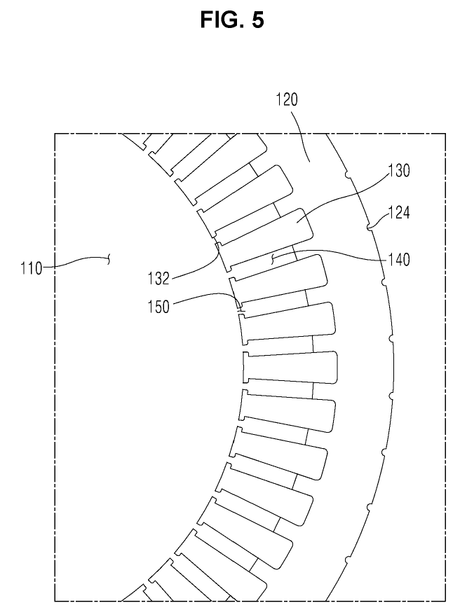

FIG. 5 is a partial sectional view illustrating external grooved portions (124) in the motor core (10) for an electric vehicle according to one embodiment of the present disclosure.

As shown in FIG. 5, in the motor core (10) according to one embodiment of the present disclosure, the back yoke part (120) may further include a plurality of external grooved portions (124) formed on its outer circumference.

The external grooved portions (124) may have the form of longitudinal grooves that are indented at regular intervals around the outer circumference of the back yoke part (120).

The width in the longitudinal direction of the external grooved portions (124) may be appropriately set according to the embodiment to which the present disclosure is applied.

The external grooved portions (124) may allow for easy alignment of coupling guides (530) according to one embodiment of the present disclosure to be described below.

The coupling guides (530) may guide the stator teeth (130) and/or the pressing units (540) that press the stator teeth (130) to be aligned at a predetermined position during the process of coupling the stator teeth (130) to the respective tooth coupling grooves (122) of the back yoke part (120).

Each of the external grooved portions (124) may additionally perform the role of a passage through which cooling fluid circulates along the outer circumference of the back yoke part (120) during operation of the motor.

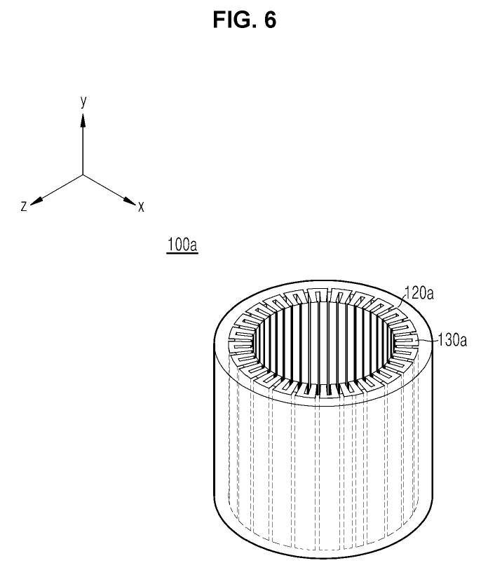

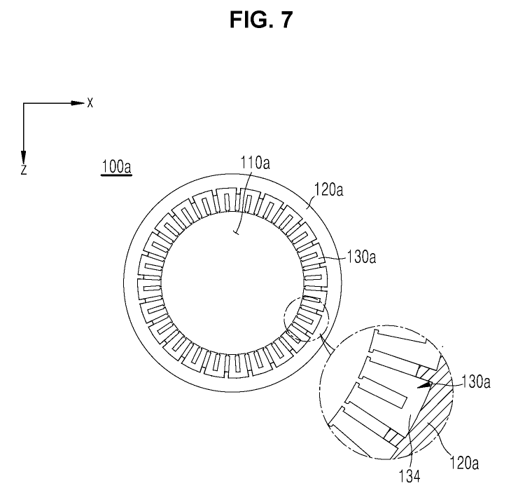

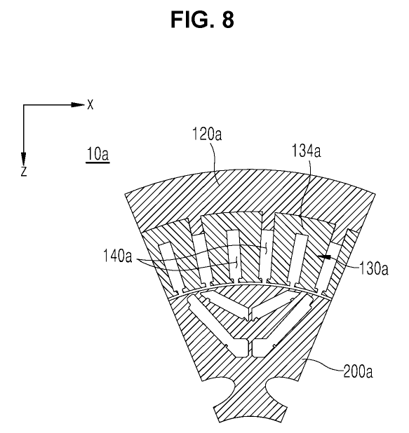

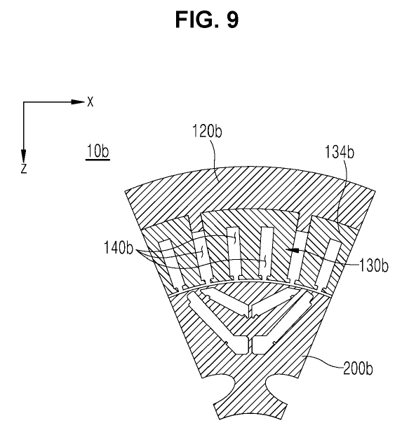

FIG. 6 is a perspective view schematically illustrating a stator core (100a) in a motor core (10a) for an electric vehicle according to another embodiment of the present disclosure, FIG. 7 is a plan view illustrating a stator core (100a) in the motor core (10a) for an electric vehicle according to another embodiment of the present disclosure, and FIGS. 8 and 9 are partial sectional views illustrating the motor core (10a) for an electric vehicle according to another embodiment of the present disclosure.

As shown in FIGS. 6 and 7, in the motor core (10a) according to another embodiment of the present disclosure, each of stator teeth (130a) may include a tooth base (134a).

The tooth base (134a) may be inserted into a tooth coupling groove (122a) formed on the inner circumference of a back yoke part (120a). A pair of tooth cores may be formed extending along respective side edges of the tooth base (134a) toward an imaginary curvature center.

That is, according to this embodiment of the present disclosure, the stator teeth (130a) may have at least two tooth cores provided on one tooth base (134a).

As shown in FIGS. 6 to 8, in this embodiment of the present disclosure, a pair of tooth cores may be provided, with one tooth core on each side of the tooth base (134a).

Tooth shoes (132a) projecting in opposite directions may be formed at the end of each tooth core.

As shown in FIG. 9, in yet another embodiment of the present disclosure, each of the stator teeth (130b) in the stator core (100b) may also consist of one tooth base (134b) and three or more tooth cores extending from it.

In this way, when each stator tooth (130b) consists of one tooth base (134b) and multiple tooth cores extending from it, the process of cutting the lamination block of thin ribbon-shaped second materials into the shape of individual stator teeth (130b) may be facilitated.

The process of assembling the stator teeth (130b) into the back yoke part (120b) may also be simplified, and the time required for assembly may also be shortened.

A method for manufacturing a motor core (10) according to one embodiment of the present disclosure will be described in further detail below.

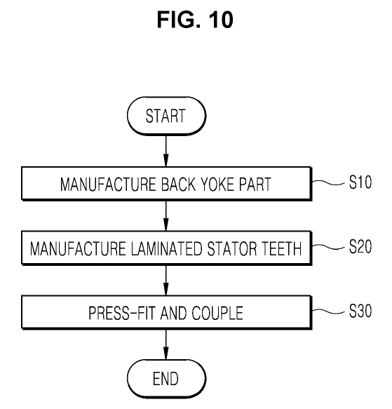

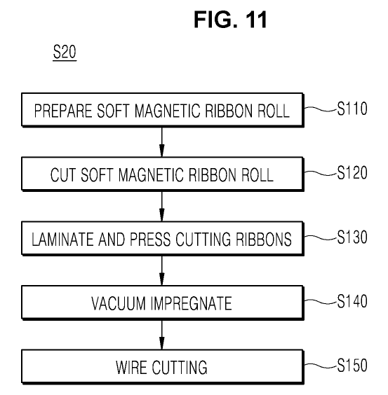

FIGS. 10 and 11 are flow charts illustrating a method for manufacturing a motor core (10) according to one embodiment of the present disclosure.

As shown in FIGS. 10 and 11, the method for manufacturing a motor core (10) according to one embodiment of the present disclosure may include manufacturing a back yoke part (S10), manufacturing stator teeth (S20), and press-fitting and coupling (S30).

The manufacturing the back yoke part (S10) may include manufacturing the back yoke part (120) to a predetermined thickness by laminating a plurality of thin film sheets made of the first material that is a ferromagnetic material.

The manufacturing the stator teeth (S20) may include manufacturing several stator teeth (130) by laminating a plurality of thin film sheets made of the second material that is a soft magnetic amorphous material or a soft magnetic nanocrystalline material.

The press-fitting and coupling (S30) may include respectively coupling the stator teeth (130) to the plurality of tooth coupling grooves (122) formed on the inner circumference of the back yoke part (120).

Specifically, the manufacturing the stator teeth (S20) may include preparing a soft magnetic ribbon roll (S110), cutting a soft magnetic ribbon roll (S120), laminating and pressing (S130), vacuum impregnating (S140), and wire cutting (S150).

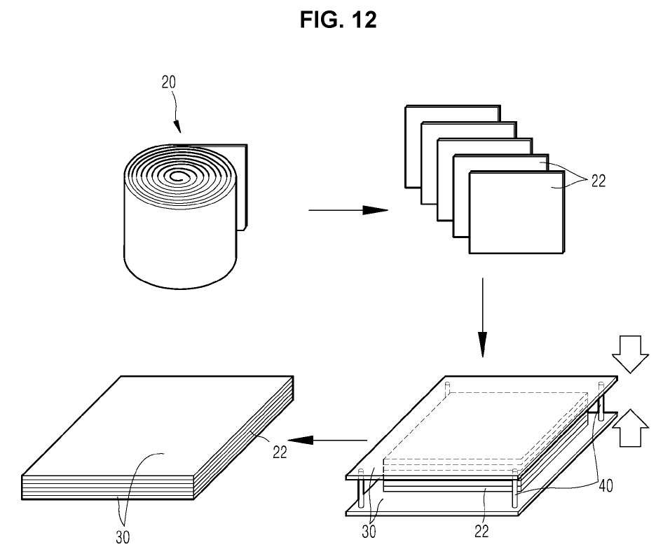

FIG. 12 is a schematic diagram illustrating a process of manufacturing stator teeth (130) in the method for manufacturing a motor core (10) according to one embodiment of the present disclosure.

As shown in FIG. 12, in one embodiment of the present disclosure, the preparing a soft magnetic ribbon roll (S110) may include preparing a ribbon roll (20) wound with thin film sheets of a constant width made of the second material that is a soft magnetic amorphous or soft magnetic nanocrystalline material.

Depending on the embodiment to which the present disclosure is applied, the preparing a soft magnetic ribbon roll (S110) may be implemented by a rapid solidification process (RSP) that melts an Fe-Si-B ternary master alloy and casts the Fe-Si-B ternary master alloy at a very high speed using a rapidly rotating copper roll.

The cutting a soft magnetic ribbon roll (S120) may include unwinding the second material in the form of thin film sheets from the ribbon roll (20) in one direction and cutting the thin film sheets into predetermined width units to form several cutting ribbons (22).

The cut plurality of cutting ribbons (22) go through the laminating and pressing (S130) where the cutting ribbons are primarily bound by being pressed in a direction where both sides face each other in a state of being laminated on top of each other.

In the laminating and pressing (S130), a pair of steel plates (30) and a plurality of coupling units (40) may be utilized.

As shown in FIG. 12, steel plates (30) may be placed in contact with the respective outermost surfaces of the laminated second materials, and a plurality of coupling units (40) may be coupled to the pair of steel plates (30).

The pair of steel plates (30) may be adjusted to narrow the gap between them through the coupling units (40), and accordingly, the multiple layers of thin film sheets made of the second material interposed between the steel plates (30) may be pressed.

The primarily bound cutting ribbons (22) or the cutting ribbons (22) interposed between the steel plates (30) may go through the vacuum impregnating (S140).

The vacuum impregnating (S140) allows air, moisture, or foreign substances inside the primarily bound lamination block to be removed in a vacuum state, and predetermined functional materials may be injected into the space where air, moisture, or foreign substances have been removed.

In the method for manufacturing a motor core (10) according to one embodiment of the present disclosure, the manufacturing the stator teeth (S20) may further include bonding.

The bonding is a process of more firmly secondarily binding a lamination block made of the second material by applying an adhesive to the side of the lamination block that has gone through the vacuum impregnating (S140).

Depending on the embodiment to which the present disclosure is applied, the bonding may be omitted.

The wire cutting (S150) may include processing a lamination block into the shape of a stator tooth (130) of a predetermined shape.

Apart from the aforementioned embodiments, the stator teeth (130) may also be manufactured through a process of continuously punching, laminating, bonding, and curing the second material.

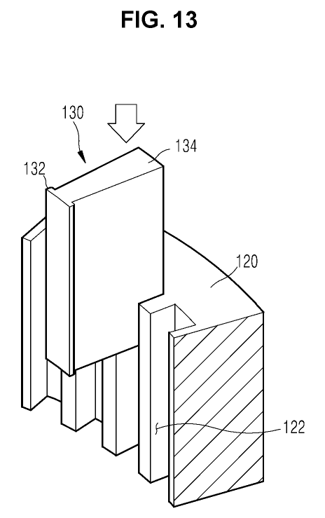

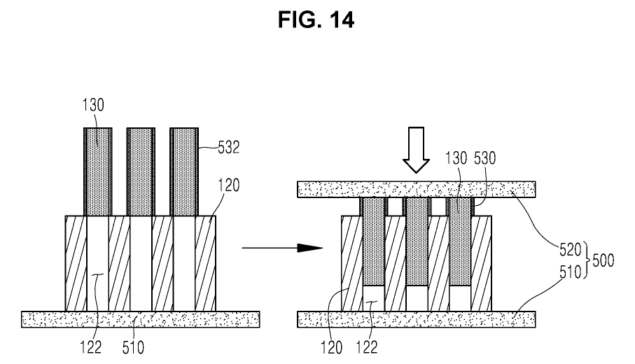

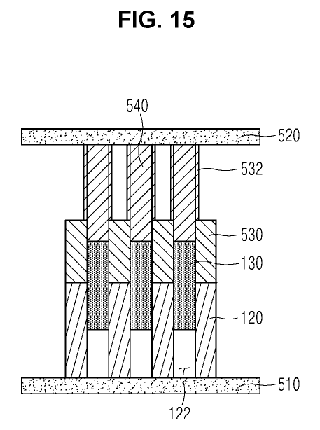

FIGS. 13 to 15 are schematic diagrams illustrating a process of coupling each stator tooth (130) to the back yoke part (120) through the method for manufacturing a motor core (10) according to one embodiment of the present disclosure.

As shown in FIGS. 13 to 15, in the method for manufacturing a motor core (10) according to one embodiment of the present disclosure, the press-fitting and coupling (S30) may couple the back yoke part (120) and the plurality of stator teeth (130) through an assembly press (500).

Specifically, the assembly press (500) may include a lower die (510) and an upper die (520).

The back yoke part (120) may be placed on the lower die (510) and fixed.

The upper die (520) may press the plurality of stator teeth (130) from top to bottom so that the stator teeth (130) may be slidably coupled to the respective tooth coupling grooves (122) of the back yoke part (120) fixed on the lower die (510).

At this time, a coupling guide (530) may be placed between each stator tooth (130) so that each stator tooth (130) may be aligned with a corresponding tooth coupling groove among the plurality of tooth coupling grooves (122) formed in the back yoke part (120).

A predetermined lubricating film may be formed through a lubricating member (532) on the outer side of the tooth base (134) of each stator tooth (130) so that each stator tooth (130) may be smoothly coupled to the corresponding tooth coupling groove (122).

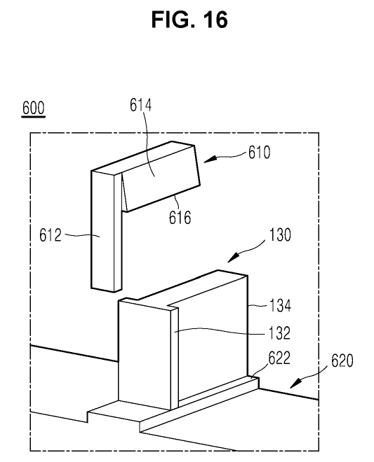

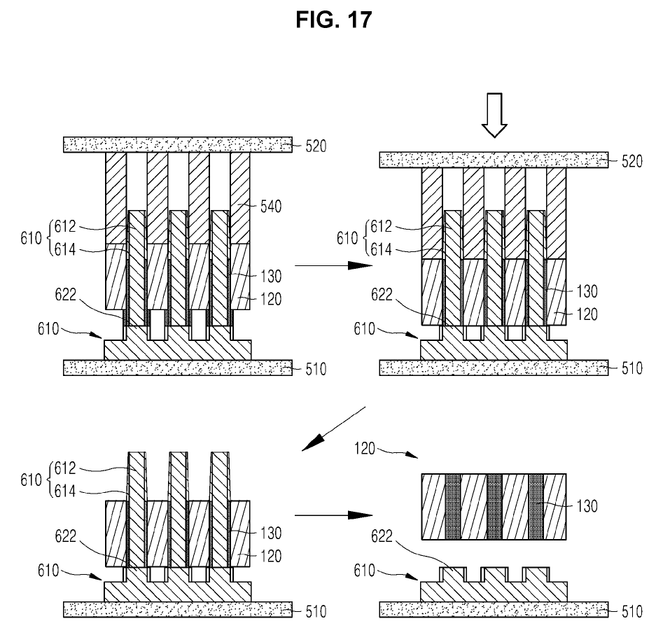

FIGS. 16 and 17 are schematic diagrams illustrating a process of each stator tooth (130) being fixed on the lower die (510) through a fixing module (600) and coupled to the back yoke part (120) in the method for manufacturing a motor core (10) according to another embodiment of the present disclosure.

As shown in FIGS. 16 and 17, in the method for manufacturing a motor core (10) according to this embodiment of the present disclosure, the stator teeth (130) may be fixed to the lower die (510) of the assembly press (500).

The stator teeth (130) may be fixed on the lower die (510) through a fixing module (600) as shown in FIG. 16.

The fixing module (600) may include a lower jig (620) having a resting step (622) coupled to one side of the lower jig (620) and formed as a step protruding upward, and an upper jig (610) that presses and fixes the corresponding stator tooth (130) from above the lower jig (620).

The upper jig (610) may include a main column (612), a fixing arm (614), and a teeth contact surface (616).

The main column (612) may have its lower end in contact with the resting step (622) of the lower jig (620), and may be a linear member arranged lengthwise up and down along one side of the corresponding stator tooth (130).

The fixing arm (614) may be formed extending to one side from the upper end of the main column (612), and may include a teeth contact surface (616), which is a flat surface facing downward.

The fixing arm (614) may press the upper surface of each stator tooth (130) from top to bottom.

In this way, each stator tooth (130) may be fixed to the lower die (510) through the fixing module (600) that wraps around its bottom surface, the surface opposite to the tooth base (134), and the upper surface.

In this way, a plurality of pressing units (540) provided on the upper die (520) may press the back yoke part (120) from top to bottom toward the plurality of stator teeth (130) fixed to the lower die (510), so that the plurality of tooth coupling grooves (122) formed in the back yoke part (120) are coupled the respective stator teeth (130) fixed to the lower die (510).

Embodiments of the present disclosure have been described above with reference to the drawings. The described embodiments and drawings are merely exemplary and may be variously modified within the scope of the technical idea of the present disclosure.

The described embodiments should be considered as part of the present disclosure, and the scope of the present disclosure is not limited to these embodiments.

The scope of the present disclosure should be determined according to the technical idea set forth in the claims.

In addition, even if certain operations or effects are not explicitly stated in the described embodiments, predictable operations or effects from the configurations are included in the scope of the present disclosure.

1. A motor core for an electric vehicle, the motor core comprising:
a back yoke part formed of a first material that is a ferromagnetic material and having a cylindrical shape;
a plurality of tooth coupling grooves formed as straight longitudinal grooves on an inner circumference of the back yoke part and formed at regular intervals; and
a plurality of stator teeth respectively coupled to the tooth coupling grooves and forming stator slots where stator windings are coupled,
wherein the stator teeth are made of a second material that is a soft magnetic amorphous material.

2. The motor core of claim 1, wherein the back yoke part is formed by laminating and coupling a plurality of thin film sheets made of the first material.

3. The motor core of claim 1, wherein the stator teeth are formed by laminating and coupling a plurality of thin film sheets made of the second material.

4. The motor core of claim 1, wherein each of the plurality of stator teeth comprises:
a tooth base coupled along a longitudinal direction of a corresponding tooth coupling groove;
a pair of tooth cores, with one tooth core provided on each side of the tooth base and projecting along a longitudinal direction of the tooth base; and
tooth shoes projecting from opposite sides of an end of each tooth core.

5. The motor core of claim 1, wherein each of the plurality of stator teeth comprises:
a tooth base coupled along a longitudinal direction of a corresponding tooth coupling groove;
a plurality of tooth cores provided on one surface of the tooth base and projecting, in parallel at regular intervals, in one direction from the one surface of the tooth base; and
tooth shoes projecting from opposite sides of an end of each tooth core.

6. A method for manufacturing a motor core for an electric vehicle, the method comprising:
manufacturing a back yoke part by laminating a plurality of thin film sheets made of a first material that is a ferromagnetic material;
manufacturing stator teeth by laminating a plurality of thin film sheets made of a second material that is a soft magnetic amorphous material; and
press-fitting and coupling a plurality of the stator teeth to an inner circumference of the back yoke part.

7. The method of claim 6, wherein the manufacturing the stator teeth comprises:
preparing a soft magnetic ribbon roll wound with thin film sheets of a constant width made of the second material that is a soft magnetic amorphous material;
unwinding the second material in the form of thin film sheets from the soft magnetic ribbon roll, and cutting the unwound thin film sheets into cutting ribbons having a predetermined width;
laminating and pressing a predetermined number of the cutting ribbons to primarily bind the cutting ribbons;
vacuum impregnating the primarily bound cutting ribbons; and
processing a lamination block that has undergone the vacuum impregnation into a predetermined shape.

8. The method of claim 7, further comprising applying an adhesive to at least one side of the lamination block that has been vacuum impregnated through the vacuum impregnation, to secondarily bind the lamination block.

9. The method of claim 7, wherein the laminating and pressing comprise a pair of plate-shaped steel plates each having an area larger than the cutting ribbons which are coupled to respective sides of the laminated plurality of cutting ribbons.

10. The method of claim 9, wherein in the laminating and pressing, a gap between the pair of steel plates is narrowed by a plurality of coupling units connecting the pair of steel plates, such that the plurality of cutting ribbons disposed between the pair of steel plates is compressed.

11. The method of claim 6, wherein in the press-fitting and coupling, the back yoke part is fixed on a lower die, and an upper die presses the stator teeth from top to bottom to couple the stator teeth to respective tooth coupling grooves formed in the fixed back yoke part.

12. The method of claim 6, wherein in the press-fitting and coupling, the stator teeth are placed on top of a lower die in a state of being temporarily fixed on the lower die by a fixing module, and a plurality of pressing units provided on one side of an upper die press the back yoke part toward the stator teeth placed on top of the lower die to couple each stator tooth to a corresponding tooth coupling groove among a plurality of tooth coupling grooves provided in the back yoke part.

13. A method for manufacturing a motor core for an electric vehicle, the method comprising:
laminating a plurality of thin film sheets made of a first material to form a back yoke part;
laminating a plurality of thin film sheets made of a second material that is a second material softer than the first material to form stator teeth; and
press-fitting and coupling a plurality of the stator teeth to an inner circumference of the back yoke part.

14. The method of claim 13, wherein the first material is a ferromagnetic material and the second material is magnetic amorphous material.

15. The method of claim 13, wherein forming the stator teeth further comprises:
preparing a magnetic ribbon roll wound with thin film sheets of a constant width made of the second material;
unwinding the second material in the form of thin film sheets;
cutting the unwound thin film sheets into cutting ribbons having a width;
laminating and pressing a predetermined number of the cutting ribbons to bind the cutting ribbons;
vacuum impregnating the bound cutting ribbons.

16. The method of claim 15, further comprising:
processing a lamination block that has undergone the vacuum impregnation into a desired shape.
